(19) United States
(12) Patent Application Publication
(10) Pub. No.: US 2006/0048205 A1
(43) Pub. Date: Mar. 2, 2006

(54) Methods and systems for securing access to recorded video programs

(76) Inventor: Thomas Poslinski, Elma, NY (US)

Correspondence Address: Steven L. Nichols;Rader, Fishman & Grauer PLLC, River Park Corporate Center One, River Front Pkway., Ste. 150, South Jordan, UT, 84095, US

(21) Appl. No.: 10/926,607

(22) Filed: Aug. 26, 2004

(51) Int. Cl. H04N 7/173; H04N 7/16

(52) U.S. Cl. 725/134; 725/142; 725/89

(57) ABSTRACT

A video recorder for recording audiovisual programming includes: a storage device for recording audiovisual programming and a list of users; a processor for controlling the storage device; and a user interface. The processor is configured to selectively grant access to a particular audiovisual recording based on a list of authorized users selected from the list of users. Another video recorder includes: a storage device for recording audiovisual programming; a processor for controlling the storage device; and a user interface. The processor is configured to selectively require a system password before allowing access to any particular audiovisual recording that is indicated as locked.

### BACKGROUND

In most video or home entertainment systems, a television or video monitor is used to watch broadcast and recorded television programming. The broadcast signal carrying the programming shown on the television set may come from, for example, a terrestrial antenna, a cable television system or a satellite dish. Modern users may have access to hundreds of channels of programming as well as pay-per-view service, video-on-demand service and other services.

In most such system, additional electronics are needed to allow the television set to access and display the variety of available programming. These additional electronics are typically incorporated into a terminal, known as a set-top box. The set-top box is connected to the television set and provides a programming signal for the television set to display. The set-top box is also connected to a signal source, for example, a cable television system or satellite dish, and processes a programming signal from that signal source into a form that can be used and displayed by the television set.

In addition to providing access to the programming from a cable or satellite service provider, a set-top box may also perform other functions for the user. For example, the set-top box may incorporate a video recorder that can record video programming for later playback as desired by a user.

Video recorders, whether incorporated into a set-top box or provided as a separate unit, allow a user to record and replay video and television programming. Modern video recorders store the recorded programming digitally on a mass data storage device, such as a hard drive. Such video recorders are known as Personal Video Recorders (PVRs) or Digital Video Recorders (DVRs).

### SUMMARY

A video recorder for recording audiovisual programming includes: a storage device for recording audiovisual programming and a list of users; a processor for controlling the storage device; and a user interface. The processor is configured to selectively grant access to a particular audiovisual recording based on a list of authorized users selected from the list of users. Another video recorder includes: a storage device for recording audiovisual programming; a processor for controlling the storage device; and a user interface. The processor is configured to selectively require a system password before allowing access to any particular audiovisual recording that is indicated as locked.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a diagram showing a video recorder and television set according to principles described herein.

FIG. 2 is an illustration of one screen of an exemplary user interface according to principles described herein for selectively granting access to a recording.

FIG. 3 is another illustration of the user interface of FIG. 2.

FIG. 4 is an illustration of another screen of an exemplary user interface according to principles described herein for selecting a recorded program for playback.

FIG. 5 is an illustration of another screen of an exemplary user interface according to principles described herein for accessing a recorded program.

FIG. 6 is an illustration of another screen of an exemplary user interface according to principles described herein for accessing a recorded program and editing access rights to that program.

FIG. 7 is a flowchart illustrating operation of a video recorder according to principles described herein.

FIG. 8 is a flowchart illustrating operation of a password protection feature of a video recorder according to principles described herein.

FIG. 9 is flowchart further illustrating operation of the password protection feature of a video recorder according to principles described herein.

FIG. 10 is an illustration of one screen of an exemplary user interface according to principles described herein for locking a program to be recorded.

FIG. 11 is an illustration of one screen of an exemplary user interface according to principles described herein for selectively locking a previously recorded program.

Throughout the drawings, identical reference numbers designate similar, but not necessarily identical, elements.

### DETAILED DESCRIPTION

As used herein and in the following claims, the term “video recorder” will be broadly defined to mean any device for recording audiovisual, video or television programming, for example, a Personal Video Recorder or Digital Video Recorder. The video recorder may be incorporated into a set-top box or may be a separate unit. As noted above, a set-top box can enable access to the various channels of television programming and other services offered by a service provider. The term “service provider” will be understood to mean any party providing services to a set-top box or video recorder including, but not limited to, a terrestrial television broadcasting company, a cable television company or a satellite television company.

While service providers may make hundreds of channels of programming and other services available to users, it will be understood, however, that not all such programming, whether recorded or broadcast, will be appropriate for all members of a household or for all users of a particular entertainment system. For example, if there are children that use the system, there may be programming available from the service provider or recorded on the video recorder that is not appropriate for viewing by children. Additionally, a user may simply desire some privacy and not want recordings he or she has made to be available to all users of the system.

To address these situations, a video recorder, as described herein, may be programmed to recognize different users and provide different access privileges depending on the user operating the recorder. A user profile is created and stored on the video recorder for each individual user who wants to use the video recorder. For example, if an adult logs into a video recorder or set-top box by providing a password or other identifier, the video recorder will access the user profile for that user and may then allow the adult to access any recordings stored on the video recorder. However, if a child logs into the video recorder by providing a password or other identifier, the set-top box will access the user profile for the child user and note that they child may not be given access to some of the recordings stored on the video recorder.

A user profile and corresponding specific restrictions can be set for any number of users of a video recorder. One of the users of the video recorder, for example, a parent or adult, will be the principal user or system administrator with the authority to create and define restrictions for other users. In this way, parents have some control over what programming, broadcast or recorded, is accessed and viewed by the children in the household. Additionally, each user has some privacy as to the programming he or she has chosen to record for subsequent playback.

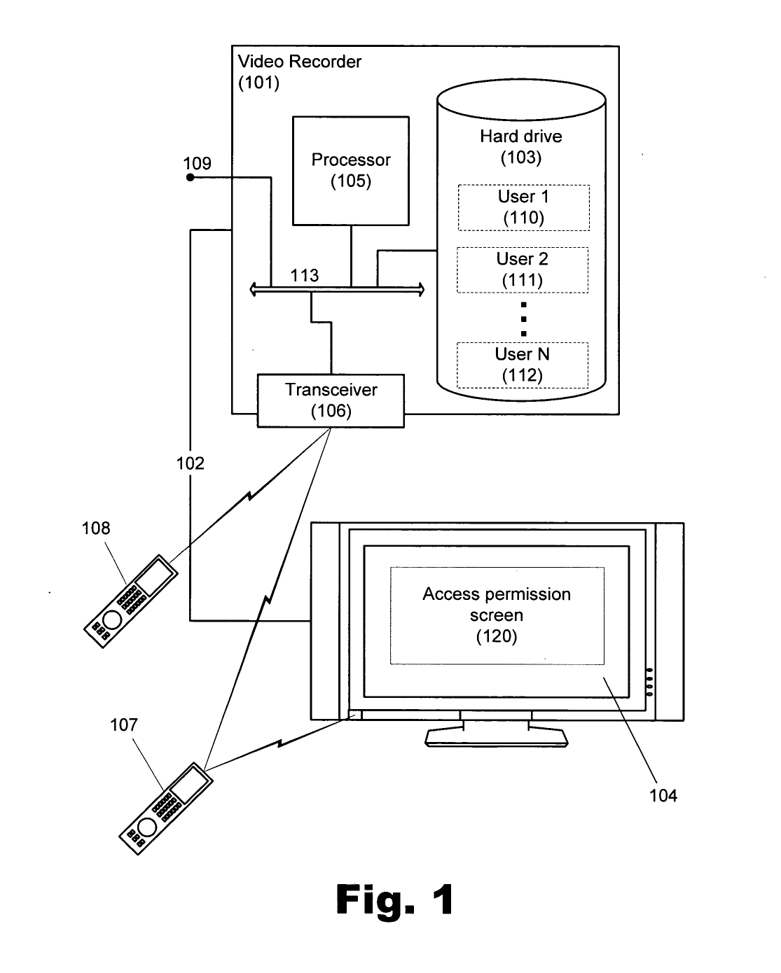

FIG. 1 is a diagram showing a video recorder and television set according to principles described herein. As shown in FIG. 1, a video recorder (101) is connected to a television set (104) via a connection (102). This video recorder (101) may also be incorporated into a set-top box and/or have a connection (109) for receiving signals from a service provider. If the video recorder (101) is also functioning as a set-top box, a processor (105) in the video recorder (101) processes video signals from the service provider and outputs programming signals that can be displayed by the television set (104). The video recorder (101) may also provide access to other services from the service provider such as pay-per-view programming, video-on-demand programming, etc.

Additionally, the illustrated video recorder (101) can record and playback video programming as desired by a user. The video recorder (101) includes a data storage device, in the illustrated example, a hard drive (103), on which audiovisual programming can be recorded and from which recorded programming can be played back under control of the processor (105).

Both the video recorder (101) and the television set (104) may have an associated remote control unit for allowing a user to control the operation of that device. In the illustrated example, the television (104) is controlled by a first remote control unit (107), while the video recorder (101) is controlled by a second remote control unit (108). However, as shown in FIG. 1, one remote control (107) can be configured or programmed to control both the television (104) and the video recorder (101).

The video recorder (101) includes a transceiver or receiver (106) for communicating with the corresponding remote control unit (107, 108). The television (104) will also include a transceiver or receiver for communicating with the remote control unit (107) corresponding to the television set (104). The transceiver (106) of the video recorder (101) may be, for example, an infra-red receiver for receiving an infra-red signal from the remote control unit (108). In other examples, the transceiver (106) may be a radio-frequency receiver or some other wireless transceiver for communicating with the remote control unit (108). A system bus (113) interconnects the various components in the video recorder (101).

As described above, the video recorder (101) may be programmed with separate accounts or user profiles for various users. Each user identifies himself or herself with a separate password or other identifier. The password may be input to the video recorder (101) using, for example, the remote control unit (108). Each user profile may have restrictions placed thereon as to the types of programming the user can record or playback on the video recorder (101). Each user profile may also include restrictions on the channels, types of programming or services that user can access from the service provider or providers. These restrictions are stored, for example, on the hard drive (103) as part of each separate user profile, i.e., User 1 (110), User 2 (111) and User N (112).

In order to give a user some privacy when recording programming on the video recorder (101) and to prevent an authorized user from accessing recordings that are inappropriate for that user, the video recorder (101) has a user interface that allows a particular user who is recording a program to specify which other users of the system are allowed to access and playback that recording. The user who records or recorded a program, referred to as the program originator, can specify which other users have permission to access the recording at the time the recording is made or thereafter. Additionally, the principal user or system administrator may also be able to edit which users have access to a particular recording on the video recorder (101).

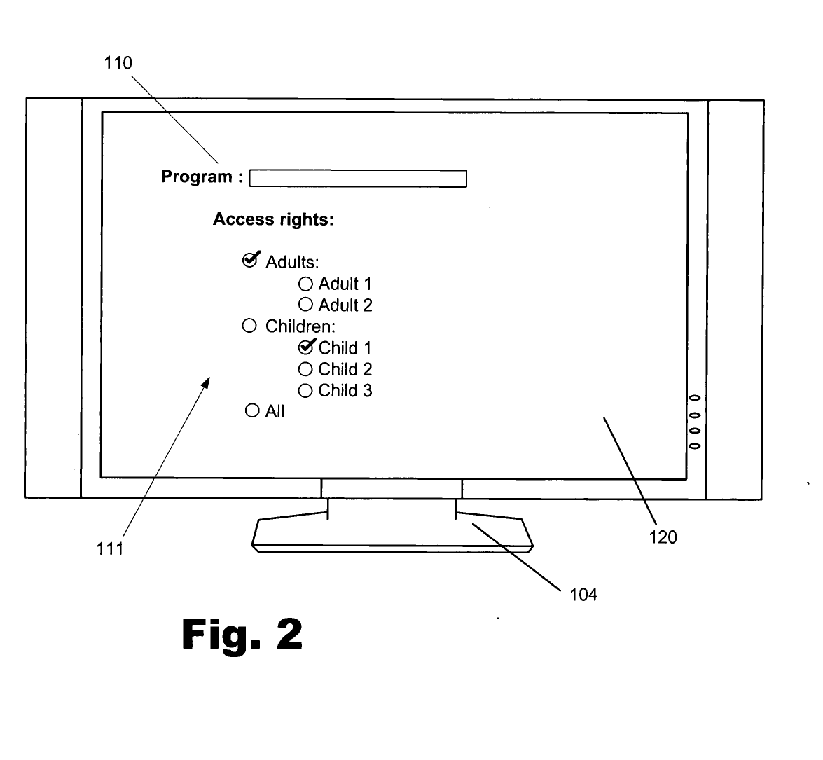

To support this feature of the video recorder (101), a user interface is provided that includes an access permission screen (120). The access permission screen (120) and other parts of the user interface for the video recorder (101) will now be described in detail with reference to FIGS. 2-7. The user interface may be controlled using a remote control unit (108, FIG. 1) or other user input device.

The user interface for the video recorder (101) may be displayed on the television (104) to which the video recorder (101) is connected or communicating. Alternatively, the user interface described herein may be displayed on a display of a remote control unit for the video recorder or on any other display associated with the video recorder.

FIG. 2 illustrates in detail the access permission screen (120) of the user interface described herein. As shown in FIG. 2, the access permission screen (120) includes an identification of a particular program (110). This program may be one that has been recorded and is stored on the video recorder or may be a program that will be broadcast that the user is programming the video recorder to record.

Additionally, the access permission screen (120) includes a list (111) of the users of the system. Each listed user can be selected or deselected. In the example shown, each listed user has a check-box associated with that user that can be checked using, for example, the buttons or keys on the remote control device. If a user is selected or checked, that user will thereafter have access to the indicated program recorded on the video recorder. Conversely, if a user is not selected, that user will not be given access to the indicated program when recorded on the video recorder.

The list (111) of users of the system may also be organized to facilitate the selection of users who will be given access to the recorded program. For example, the list (111) may include an “all” listing as shown. If “all” is selected, all the users of the system will be given access to the recorded program. In this way, it is not necessary to individually select or check each user on the list. Rather, the “all” or similar option is selected or checked. If “all” users are granted access to the recording, the system may not prompt for a password when the recording is selected for playback.

The list (111) may also be organized into groups. In the illustrated example, the users of the system are grouped as “adults” and “children.” Each group has associated with it a check-box as shown in FIG. 2. All the members of the group can then be given access to the recorded program by checking or selecting the check-box for the group, rather than having to individually select and check each member of the group.

In the example shown in FIG. 2, the check-box for the “adult” group has been checked and the check-box for Child 1 has been checked. Consequently, all the members of the adult group, Adult 1 and Adult 2, and Child 1 will have access to the recorded program (110) indicated on the screen. Child 2 and Child 3 will not have access.

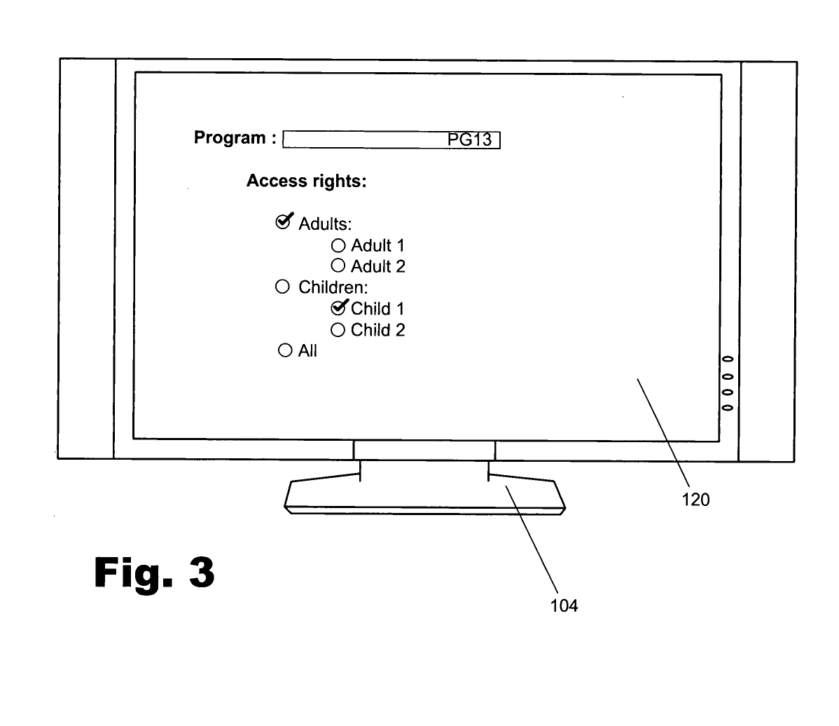

FIG. 3 illustrates another possible feature of the user interface described herein. As described above, the user profile for each user may include restrictions on the type of programming that user is allowed to record and/or playback. For example, these restrictions may be based on the movie or television rating associated with the program.

As shown in FIG. 3, the indicated program has a PG13 rating. In this example, the profile for Child 3 includes a restriction against watching or recording programs with a PG13 or higher rating. Consequently, Child 3, who was listed on the screen shown in FIG. 2, is not listed on the permission access screen (120) as shown in FIG. 3. Alternatively, Child 3 could be listed, but “grayed out” or otherwise unavailable for selection. Consequently, Child 3 cannot be given access to the recording of the indicated PG13 program based on the restrictions in the user profile for Child 3.

Thus, if there is an existing restriction against a particular user accessing the indicated program, the access permission screen will not allow that user to be selected to receive access to the indicated program. This will prevent, for example, an older child with greater access privileges from granting inappropriate access to a younger child whose access privileges are more restricted. This can also prevent a user from granting access privileges to himself or herself when attempting to record a program that exceeds the rating or other limits set for that user. Alternatively, the system may simply refuse to allow an identified user to record a program that exceeds the rating or other limits set for that user. Thus, a user will not become the program originator with access to a program that exceeds the rating or other limits set for that user.

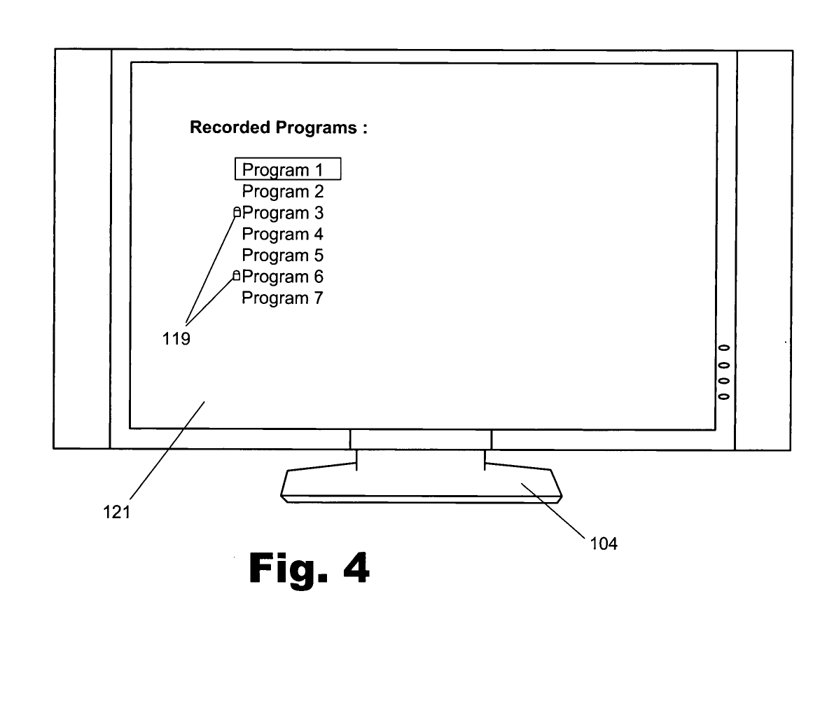

FIG. 4 illustrates another exemplary screen (121) of the user interface being described herein. This screen (122) lists the programs that are recorded on the video recorder. The user can select a program from the list that the user wants to playback. This is done, for example, with the remote control unit for the video recorder. A box or other highlight, as shown in FIG. 4, may be moved through the list of recorded programs until the desired program is indicated. The user than presses another button or input device to access and replay the indicated program. In the example of FIG. 4, Program 1 is indicated and will be accessed and replayed, if selected.

If the originator of a program or the principal user of the system has restricted access to that program, the restricted nature of the program may be indicated in the listing on the screen (121). For example, as shown in FIG. 4, recorded programs that only selected users can access are indicated with a lock icon (119) that is displayed next to the listing for that program on the screen (121).

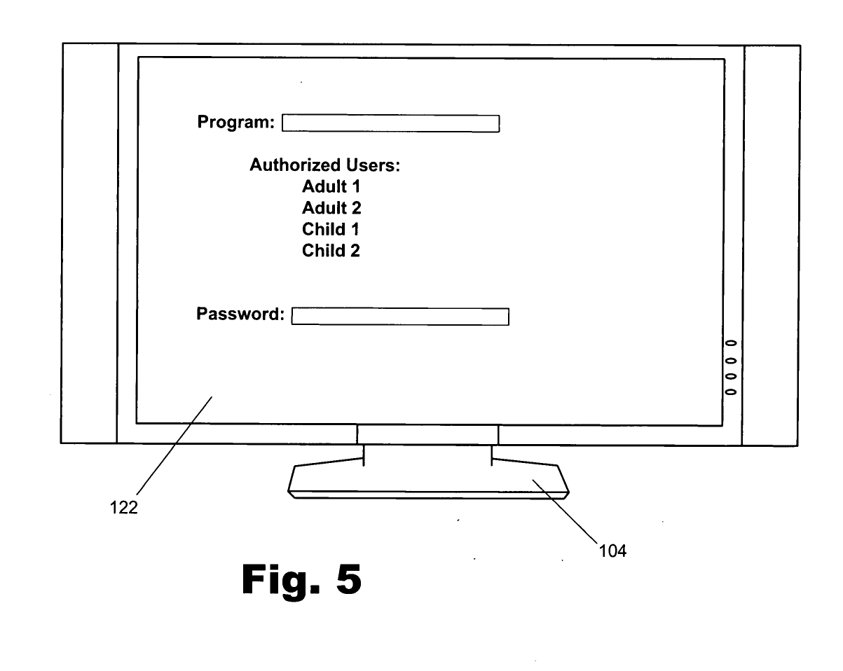

If an unrestricted or unlocked program is selected, that program is played-back by the video recorder. No password is required. If a restricted program is selected from the program listing screen (121), a password prompt screen, as shown in FIG. 5, is displayed by the user interface.

As shown in FIG. 5, the password prompt screen (122) may include an indication of the program selected, a list of the users who are authorized to access that program and a password prompt or field for entering a password. The user attempting to access the program can then input his or her password using, for example, the remote control unit for the video recorder. The password may be, for example, a numeric, alphabetic or alphanumeric string.

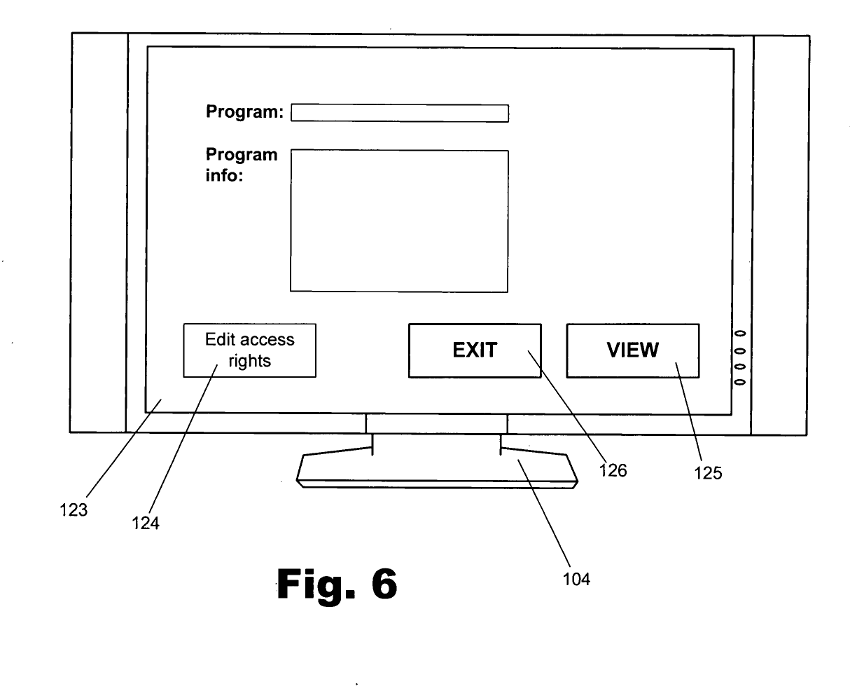

If the password input matches the password corresponding to one of the authorized users, the video recorder will then begin playback of the indicated program or may display the program information screen described below in connection with FIG. 6. However, if the password does not match, the video recorder will deny access to the indicated program. Additionally, the user interface may freeze if an attempt is made to access a program with an unauthorized password. The user interface may then refuse to make any further displays available until, for example, the password of the principal user or system administrator is input. In this way, the principal user can be alerted to unauthorized attempts to access programming on the video recorder.

If the password input on the password prompt screen (122) matched the password for one of the authorized users, the user interface may then display a program information screen (123), an example of which is shown in FIG. 6. The program information screen (123) may include an indication of the program selected as well as information about the program. This program info may include a synopsis of the program, the year the program was made, the actors in the program, etc.

The exemplary program information screen (123) also includes an exit button (126) and a view button (125). If the exit button (126) is selected, with the remote control unit for the video recorder, for example, the user interface exits the program information screen (123) and may return, for example, to the program listing screen of FIG. 4. If the view button (125) is selected, the indicated program is played back for the user.

If the password entered in the previous password prompt screen (122) is that of the originator of this particular program or the password of the principal user or system administrator, the program information screen (123) may include a button (124) for editing the access rights to the indicated program. If this button is selected, the user interface will display the access permission screen (120) of FIG. 2 so that the user can edit the list of those users who have access to the selected program recording.

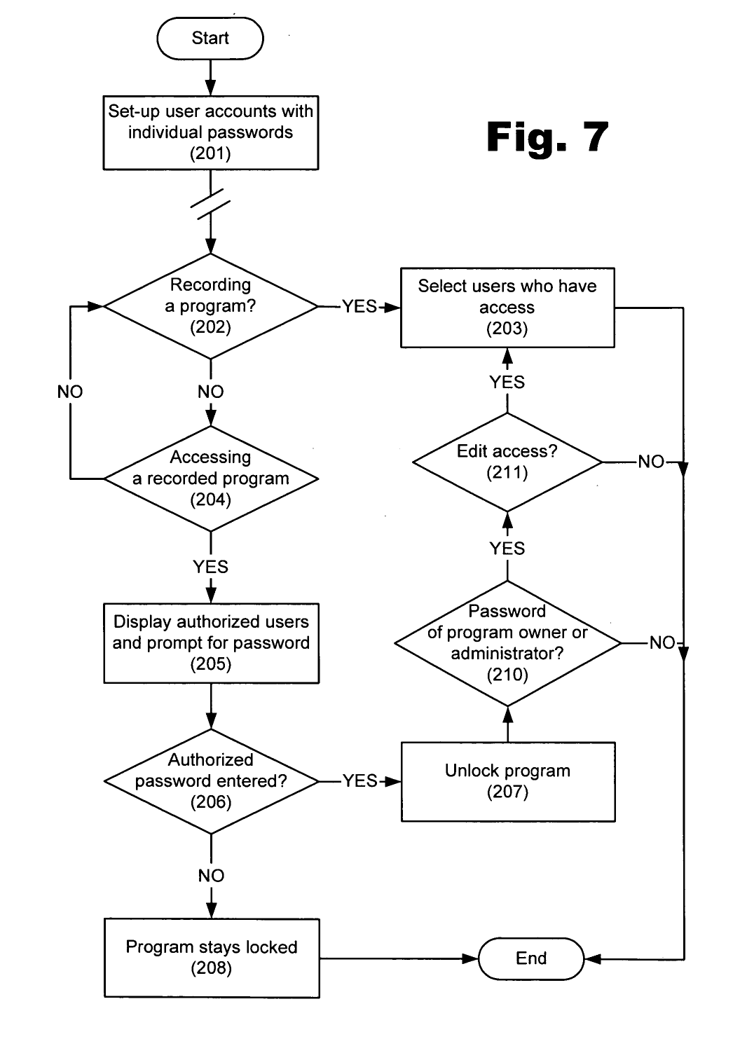

FIG. 7 is a flowchart illustrating on example of the operation of the user interface and the various user interface screens described above. As shown in FIG. 7, the system is initially set-up by creating user accounts with corresponding user profiles that identify and, in some cases, provide restrictions for, the individual users of the system (step 201). A particular user may have the ability to change his or her password as desired.

When a user decides to record a program (determination 202), either by recording live or by programming the video recorder to record the desired program, that user, the program originator, will be able to select those users who are to have access to the recording (step 203). This may be done with the access permission screen described above or other means.

When a recorded program is being accessed (determination 204), the user interface will prompt the user for an identifying password and may display a list of the users authorized to access that particular recorded program (step 205). If the password of an authorized user is entered (determination 206), the program is unlocked (step 207) and may be played back. When playback or access to the program is discontinued, the program will be automatically relocked. If the password of an authorized user is not entered (determination 206), the program stays locked (step 208) and the system may freeze, refusing to perform further functions until reset by the principal user or system administrator.

Once the program is unlocked by an authorized user (step 207), the programming can be played back. If the user accessing the program is the originator of the program or the system administrator (determination 210), that user will have the option to edit the access privileges of the other users to that program. If the user decides to edit the access to the program (determination 211), that user, the program originator or system administrator, will be able to select those users who are to have access to the recording (step 203). This may be done with the access permission screen described above.

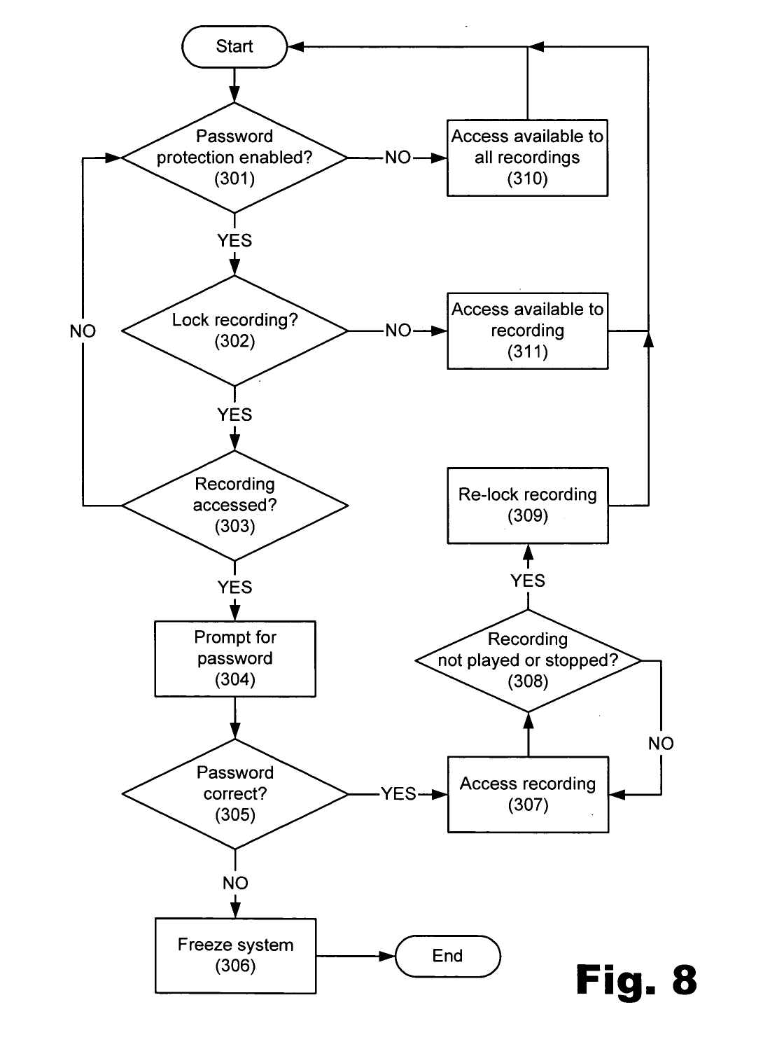

FIG. 8 illustrates another system that may be incorporated into a video recorder (101, FIG. 1) to prevent unauthorized and inappropriate access to recorded programs. As described above, a video recorder may be programmed to prevent access to certain channels, types of programs, programs with particular ratings, etc. These restrictions may be referred to generally as locks and limits. In some systems, the locks and limits are either engaged and apply to all users or are disengaged. Thus, it is possible that a program may be recorded by the video recorder when the locks and limits are deactivated that could not have been tuned and recorded if the locks and limits had been engaged. Such a program, which may be inappropriate for some users, e.g., children, may then be accessible on the video recorder, even if the locks and limits are re-engaged to prevent reception of further inappropriate programming.

Additionally, if the video recorder also includes the system described above for providing selective access to recordings, it would be possible for a restricted user to surreptitiously learn the password of a less restricted user and then use that password to gain unauthorized access to inappropriate programming. Alternatively, a user may find the system described above too cumbersome. A user may not want to select and specify which users of a system should have access to a program. Rather, the system administrator may simply desire the ability to easily lock all users out of a program unless they have a system password.

FIG. 8 illustrates a system that addresses these scenarios. The system illustrated in FIG. 8 includes a user interface for a video recorder that allows a user to designate any program as locked or restricted such that access to that program thereafter can only be obtained by entering a system password. This feature can be active independent of whether general locks and limits for the system are engaged. Additionally, this password protection feature can be enabled or disabled (determination 301) as desired by the system administrator or master user. If the password protection feature is not enabled, and no other system of locks or restrictions is in place, access will be available to all recordings on the video recorder (step 310).

If the password protection feature is enabled (determination 301), the users will have the option of locking a recording (determination 302). This can be done after the program is recorded, while the program is being recorded live or when the recorder is being programmed to record the particular program in question. If the user does not lock the recording (determination 302), access will be available for any user to that particular recording (step 311).

With the password protection feature enabled and a recording locked, if a user attempts to access the recording (determination 303), the user interface will prompt the user for the system password (step 304). If the system password is entered correctly (determination 305), the video recorder will give the user access to the recording (step 307). If the system password is not correctly entered, access to the recording will be denied. Moreover, the user interface may freeze (step 306), as described above, until reset by the system administrator. This alerts the system administrator to unauthorized attempts to access locked programming.

If an authorized user gains access to a recording, but does not play the recording or interrupts the playback of the recording (determination 308), the recording will automatically go back into a locked state. This may or may not occur if the user simply pauses, but does not stop, the playback of the program. If the program is re-locked (step 309), the system password will have to be re-entered to regain access to the program. In this way, a program is not inadvertently left unlocked and available to unauthorized users.

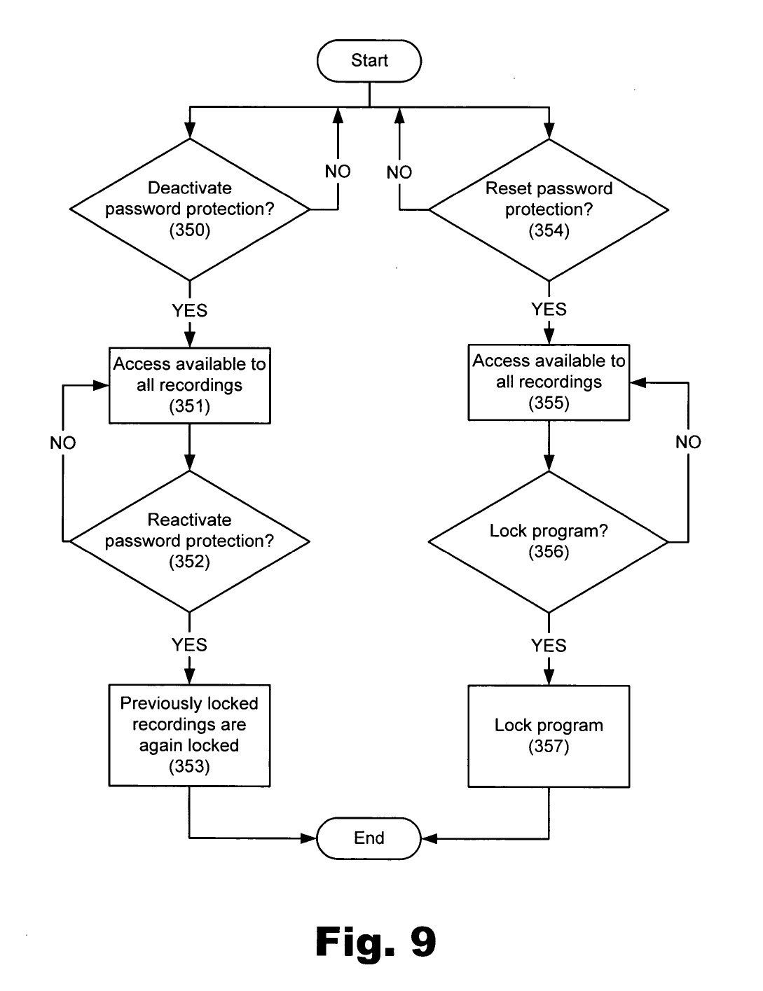

FIG. 9 illustrates that the password protection feature described above can be selectively deactivated by the master user or system administrator. As shown in FIG. 9, if the system administrator deactivates the password protection features (determination 350), access is then available to all recordings on the video recorder (step 351).

However, if a program was locked, a “locked” flag will be set in connection with the recording of that program on the storage device of the video recorder, for example, the hard drive (103, FIG. 1). The locked flag can be a single bit in the meta-data portion of the recording for each recorded program. When the password protection feature is subsequently reactivated (determination 352), any recording for which the “locked” flag has been set or turned on will again be locked and accessible only upon entry of the system password (step 353).

The system administrator will also have the option of resetting the password protection feature. If the password protection feature is reset (determination 354), the “locked” flag for all recordings on the video recorder will be turned off and access will be available to all recordings for any user (step 355). Users, including the system administrator, can then selectively decide to lock any particular program (determination 356). If a program is selected and locked (determination 356), the “locked” flag for that recording is set on the storage unit of the video recorder and the program is locked (step 357), meaning that access to that recorded program will require entry of the system password if the password protection feature is enabled.

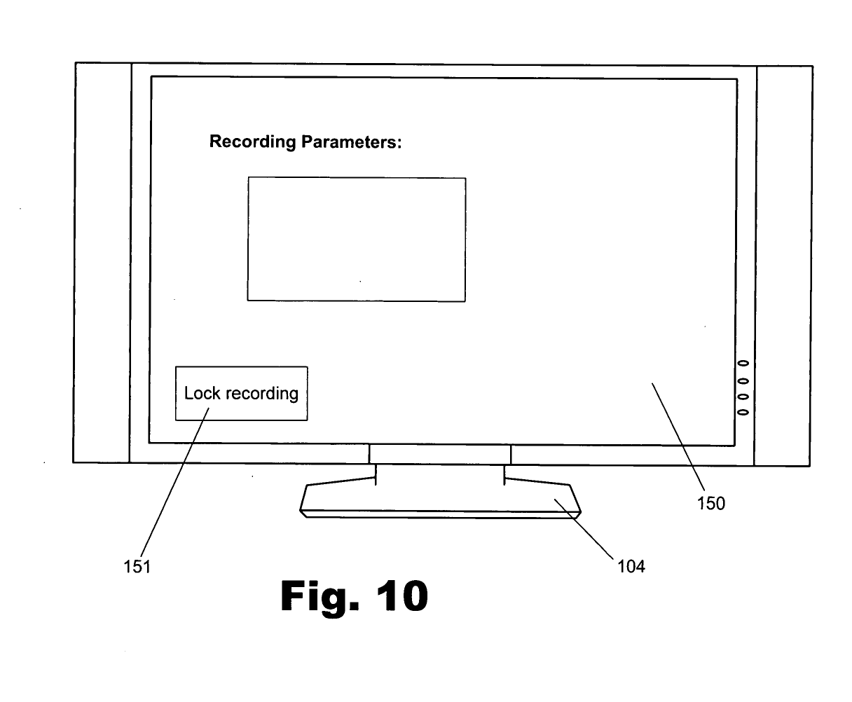

FIG. 10 illustrates an exemplary user interface screen (150) for the system of FIGS. 8 and 9. As shown in FIG. 10, when a user is programming the video recorder to record a particular program, the user inputs the recording parameters, such as channel, time, length of program to record, etc. This screen (150) may also include a lock button (151). If the lock button (151) is selected, the recording made will be locked, i.e., the locking flag will be set for the recording on the video recorder. Then, if the password protection feature is enabled, access to the recording will require entry of the system password. The locking button (151) may also be displayed if the user initiates live recording of a program and will then function in the same manner.

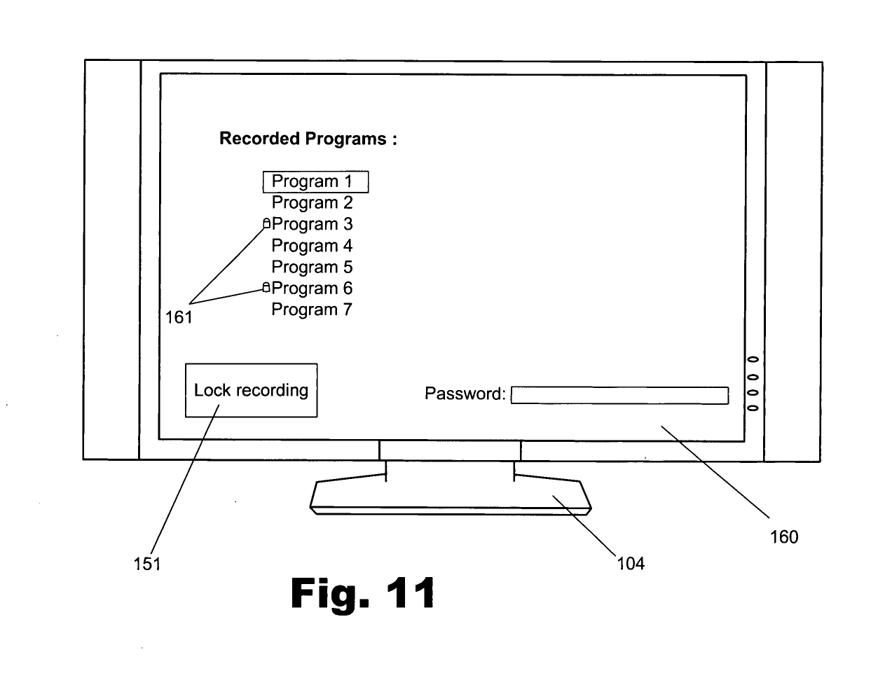

FIG. 11 illustrates another exemplary user interface screen (160) for the system of FIGS. 8 and 9. As shown in FIG. 11, the user interface has a screen (160) for listing recorded programs. The user can select a program from the list that the user wants to playback. This is done, for example, with the remote control unit for the video recorder. A box or other highlight, as shown in FIG. 11, may be moved or scrolled through the list of recorded programs until the desired program is indicated. The user then presses another button or activates some other input device to access and replay the indicated program. In the example of FIG. 11, Program 1 is indicated and will be accessed and replayed, if selected.

Programs for which the locking flag has been set will be indicated with an icon (161) or other indicator. If one of these programs is selected and the password protection feature is enabled, a password prompt may appear, as shown in FIG. 11, prompting the user for the system password. As described above, access to the program selected will not be granted unless the system password is correctly input, using, for example, the remote control unit for the video recorder. The password prompt may also be displayed on a separate screen of the user interface.

The program listing screen also includes the locking button (151). If a particular program is selected from the list and the locking button (151) is selected, using the remote control unit for the video recorder, for example, that program will then be locked. The locking flag will be set or activated for that program on the storage unit of the video recorder and access to the program will then require input of the system password if the password protection feature is enabled.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A video recorder for recording audiovisual programming, said recorder comprising:
a storage device for recording audiovisual programming and a list of users;
a processor for controlling said storage device; and
a user interface;
wherein said processor is configured to selectively grant access to a particular audiovisual recording based on a list of authorized users selected from said list of users.

2. The video recorder of claim 1, wherein said user interface comprises a remote control unit.

3. The video recorder of claim 1, wherein said user interface comprises an access permission screen displaying said list of users from which said list of authorized users is selected for a particular audiovisual recording.

4. The video recorder of claim 3, wherein said list of users is organized into groups of users such that all users in a group are automatically selected as authorized users by selection of that group.

5. The video recorder of claim 4, wherein each user and group of users is displayed with a corresponding check-box that can be selected or deselected to authorize or unauthorized that user or group of users to access said particular audiovisual recording.

6. The video recorder of claim 3, wherein said storage device includes a user profile for each of said users, said user profile containing restrictions on audiovisual programming accessible by a corresponding user.

7. The video recorder of claim 6, wherein a user restricted from a particular audiovisual recording will not be included in said list of users on said access permission screen corresponding to said particular audiovisual recording.

8. The video recorder of claim 6, wherein a user restricted from a particular audiovisual recording will not be active in said list of users on said access permission screen corresponding to said particular audiovisual recording, such that said restricted user cannot be selected as an authorized user for said particular audiovisual recording.

9. The video recorder of claim 1, wherein said user interface further comprises a program listing screen that lists audiovisual programming recorded on said video recorder and further indicates recordings that only said list of authorized users can access.

10. The video recorder of claim 1, wherein said user interface further comprises a password prompt screen that lists said authorized users and prompts for input of a user password.

11. The video recorder of claim 10, wherein said processor only accesses a particular audiovisual recording if a password is input matching a password assigned to one of said authorized users.

12. The video recorder of claim 1, wherein said processor only accesses said particular audiovisual recording if a current user is identified as being one of said authorized users for that particular audiovisual recording.

13. The video recorder of claim 1, wherein said user interface allows editing of said list of authorized users.

14. The video recorder of claim 13, wherein said user interface allows only an originating user or system administrator to edit said list of authorized users for said particular audiovisual recording.

15. A video recorder for recording audiovisual programming, said recorder comprising:
a storage device for recording audiovisual programming;
a processor for controlling said storage device; and
a user interface;
wherein said processor is configured to selectively require a system password before allowing access to any particular audiovisual recording that is indicated as locked.

16. The video recorder of claim 15, wherein said video recorder comprises a separate system of locks and limits which is selectively engaged and disengaged.

17. The video recorder of claim 15, wherein a particular audiovisual recording is indicated as locked based on a locked flag associated with that recording on said storage device.

18. The video recorder of claim 15, wherein said user interface allows a user to activate or deactivate a password protection feature such that
if said password protection feature is active, said processor will require input of said system password before allowing access to a recording that is indicated as locked; and
if said password protection feature is deactivated, said processor will provide access to any recording on said storage device whether or not indicated as locked.

19. The video recorder of claim 15, wherein said user interface comprises controls allowing a user to specify a particular audiovisual recording as locked.

20. The video recorder of claim 15, wherein said user interface includes a password prompt that is displayed in response to an attempt to access a particular audiovisual recording that is locked.

21. The video recorder of claim 15, wherein if access to a locked audiovisual recording is granted and playback of said audiovisual recording is cancelled or interrupted, said recording is automatically re-locked.

22. The video recorder of claim 15, wherein said user interface includes controls allowing a system administrator to reset password protection such that, if said system administrator resets said password protection, all audiovisual recordings on said storage device are indicated as not locked.

23. A method of operating a video recorder for recording audiovisual programming, said method comprising selectively granting access to a particular audiovisual recording stored on a storage device of said recorder, wherein said selective granting of access is performed based on a list of authorized users selected from a list of users stored on said storage device.

24. The method of claim 23, further comprising controlling said video recorder through a user interface that comprises a remote control unit.

25. The method of claim 23, further comprising displaying said list of users from which said list of authorized users is selected for a particular audiovisual recording.

26. The method of claim 25, wherein said list of users is organized into groups of users such that all users in a group are automatically selected as authorized users by selection of that group.

27. The method of claim 25, further comprising omitting a user from said displayed list of users if a user profile for that user contains a restriction for that user as to that particular audiovisual recording.

28. The method of claim 25, further comprising preventing a user from being selected in said displayed list of users if a user profile for that user contains a restriction for that user as to that particular audiovisual recording.

29. The method of claim 23, further comprising displaying a program listing screen that lists audiovisual programming recorded on said video recorder and further indicates recordings that only said list of authorized users can access.

30. The method of claim 23, further comprising displaying a password prompt screen that lists said authorized users and prompts for input of a user password when access is requested for said particular audiovisual recording.

31. The method of claim 30, further comprising accessing a particular audiovisual recording if a password is input matching a password assigned to one of said authorized users.

32. The method of claim 23, further comprising only accessing said particular audiovisual recording if a current user is identified as being one of said authorized users for that particular audiovisual recording.

33. The method of claim 23, further comprising editing said list of authorized users.

34. A method of operating a video recorder for recording audiovisual programming, said method comprising recorder comprising selectively requiring entry of a system password before allowing access to any particular audiovisual recording that is indicated as locked, wherein recordings on a storage device of said video recorder are indicated as locked or not locked.

35. The method of claim 34, selecting engaging and disengaging a separate system of locks and limits which prevent use by said video recorder of some types of audiovisual programming.

36. The method of claim 34, further comprising indicating a particular audiovisual recording as locked or not locked with an electronic flag associated with that recording on said storage device.

37. The method of claim 34, further comprising selecting activating or deactivating a password protection feature such that if said password protection feature is active, said video recorder requires input of said system password before allowing access to a recording that is indicated as locked; and
if said password protection feature is deactivated, said video recorder will provide access to any recording on said storage device whether or not indicated as locked.

38. The method of claim 34, further comprising specifying a particular audiovisual recording as locked.

39. The method of claim 34, further comprising automatically re-locking an audiovisual recording if access to that audiovisual recording is granted and playback of said audiovisual recording is cancelled or interrupted.

40. The method of claim 34, further comprising allowing a system administrator to reset password protection such that, if said system administrator resets said password protection, all audiovisual recordings on said storage device are indicated as not locked.

41. A user interface for a video recorder for recording audiovisual programming comprising:
means for storing audiovisual recordings; and
means for selectively granting access to a particular audiovisual recording based on a list of authorized users selected from a list of users stored on said video recorder.

42. A user interface for a video recorder for recording audiovisual programming comprising:
means for storing audiovisual recordings; and
means for selectively requiring entry of a system password before allowing access to any particular audiovisual recording that is indicated as locked, wherein recordings on said video recorder are indicated as locked or not locked.
